(19) United States
(12) Patent Application Publication
(10) Pub. No.: US 2010/0259238 A1
(43) Pub. Date: Oct. 14, 2010

(54) Direct Current Converter

(76) Inventor: Chieh-Wen Cheng, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/484,248

(22) Filed: Jun. 15, 2009

(30) Foreign Application Priority Data
Apr. 9, 2009 (TW) 098111869

(51) Int. Cl. G05F 1/00

(52) U.S. Cl. 323/282

(57) ABSTRACT

A direct current converter includes a first node, a second node, an input voltage terminal end, an output voltage terminal, a control power terminal, a low-voltage end, a control module for generating a control signal, a driving-stage circuit coupled to the input voltage terminal, the first node, the second node, the control module, and the low-voltage end, an output-stage circuit coupled to the second node and the output voltage terminal, and a bootstrap circuit including a capacitor coupled between the first node and the second node, and a cascade unit coupled to the control power terminal, the first node, and the control module for controlling connection between the control power terminal and the first node according to the control signal.

### BACKGROUND OF THE INVENTION

1. Field of the Invention

The present invention is related to a direct current converter, and more particularly, to a direct current converter capable of reducing manufacturing process cost and circuit complexity.

2. Description of the Prior Art

An electronic device includes various components, each of which may operate in a different voltage level. Therefore, a DC-DC (direct current to direct current) voltage converter is definitely required to adjust (step up or down) and stabilize the voltage level in the electronic device. Originating from a buck (or step down) converter and a boost (or step up) converter, various types of DC-DC voltage converters are accordingly customized to meet different power requirements. As implied by the names, the buck converter is utilized for stepping down a DC voltage of an input terminal to a default voltage level, and the boost converter is for stepping up the DC voltage of the input terminal. With the advancement of modern electronics technology, both of the buck converter and the boost converter are modified and customized to conform to different architectures or to meet different requirements.

For example, please refer to FIG. 1, which is a schematic diagram of a bootstrap buck converter 10 of the prior art. The bootstrap buck converter 10 comprises a driving-stage circuit 100, an output-stage circuit 102, a control module 104 and a bootstrap circuit 106. In the bootstrap buck converter 10, an input terminal provides a fixed voltage Vin. By using the control module 104 and the bootstrap circuit 106 generate control signals to the driving-stage circuit 100, in order to exchange energy via an inductor between an input terminal and the output-stage circuit 102, so as to acquire a stable DC voltage source Vo with a magnitude less than the voltage Vin of the input terminal. The driving-stage circuit 100 comprises power transistors Q1, Q2 and driving units DRV_1, DRV_2. Through the driving units DRV_1, DRV_2 and the bootstrap circuit 106, the power transistors Q1, Q2 are controlled according to control signals V_CTRL, V_CTRL_B generated by the control module 104, and output a switching signal from a node Y to the output-stage circuit 102. The output-stage circuit 102 comprises an inductor L, a capacitor C and feedback resistors R1, R2. Via the inductor L, the switching signals at the node Y can exchange energy with the output terminal Vo, and the capacitor C can stabilize the voltage of the output terminal Vo and alleviate voltage variations at the output terminal. The voltage of the output terminal Vo can feedback a voltage VFB through the feedback resistors R1, R2, such that the control module 104 can accordingly generate the control signals V_CTRL, V_CTRL_B. The bootstrap circuit 106 comprises a bootstrap capacitor C_BS and a diode D_BS. Operations of the bootstrap buck converter 10 are well known to those skilled in the art, i.e. the control module 104 and the bootstrap circuit 106 generate driving signals to enable the power transistor Q1 and disable the power transistor Q2, or swap over, so as to keep the inductor L operating between a charge status and a discharge status. In such a situation, through the control signal V_CTRL and V_CTRLB, the control module 104 can adjust the switching frequency according to the feedback signal VFB generated by the feedback resistors R1, R2, to control the output voltage Vo at the desired value.

In the bootstrap buck converter 10, preferably, the driving units DRV_1, DRV_2 are inverters, driven by node voltages V_X, V_Y of nodes X and Y, the input voltage Vin and a low-potential voltage Vss. The node X is located between the bootstrap capacitor C_BS and the diode D_BS, and the node Y is located among the driving-stage circuit 100, the output-stage circuit 102 and the bootstrap circuit 106. When the power transistor Q2 is enabled, the node voltage V_Y approaches the low-potential voltage Vss, and a control power voltage Vcc charges the bootstrap capacitor C_BS via the diode D_BS. On the contrary, when the power transistor Q2 is disabled, the node voltage V_Y transiently increases to approach the input voltage Vin. Meanwhile, since energy stored in the bootstrap capacitor C_BS is not exhausted, the node voltage V_X would increase to a magnitude equal to the node voltage V_Y plus the control power voltage Vcc, great enough to activate the driving unit DRV_1. Thus, when the bootstrap buck converter 10 switches from the mode “Q1: disable; Q2: enable” to the mode “Q1: enable; Q2: disable”, the bootstrap capacitor C_BS can transiently increase the node voltage V_X by the bootstrap circuit 106, to activate the driving unit DRV_1.

In the bootstrap circuit 106, when forward biased, a cross-voltage of the diode D_BS is equal to a threshold voltage; when reverse biased, the cross-voltage of the diode D_BS is equal to the control power voltage Vcc. Therefore, a voltage bearing ability of the diode D_BS must be greater than the control power voltage Vcc. In such a situation, due to limitations from manufacturing processes, preferably, the bootstrap circuit 106 is positioned outside a chip, or requires exclusively-customized manufacturing processes to enhance the voltage bearing ability of the diode D_BS, causing increases in manufacturing cost and circuit complexity.

Therefore, enhancing the bootstrap circuit in the buck converter has been one of the objectives and the industry is focusing on.

### SUMMARY OF THE INVENTION

It is therefore a primary objective of the claimed invention to provide a direct current converter, to overcome disadvantages of the prior art.

The present invention discloses a direct current converter for converting an input voltage to an output voltage. The direct current converter comprises a first node, a second node, an input voltage terminal for receiving the input voltage, an output voltage terminal for outputting the output voltage, a control power terminal coupled to a voltage as a voltage source for a bootstrap circuit, a low-voltage end coupled to a low-potential voltage, a control module for generating a control signal, a driving-stage circuit coupled to the input voltage terminal, the first node, the second node, the control module and the low-voltage end for being driven by a voltage of the first node, the input voltage and the low-potential voltage. This driving-stage circuit can convert the input voltage to the switching signals and output the switching signals to the second node according to the control signal, an output-stage circuit coupled to the second node and the output voltage terminal for converting the switching signals to the output voltage, and a bootstrap circuit comprising a capacitor coupled between the first node and the second node, and a cascade unit coupled to the control power terminal, the first node and the control module for controlling a connection between the control power terminal and the first node according to the control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a bootstrap buck converter of the prior art.

FIG. 2 is a schematic diagram of a direct current converter according to an embodiment of the present invention.

FIG. 3 is a schematic diagram of an alternative embodiment of the direct current converter of FIG. 2.

### DETAILED DESCRIPTION

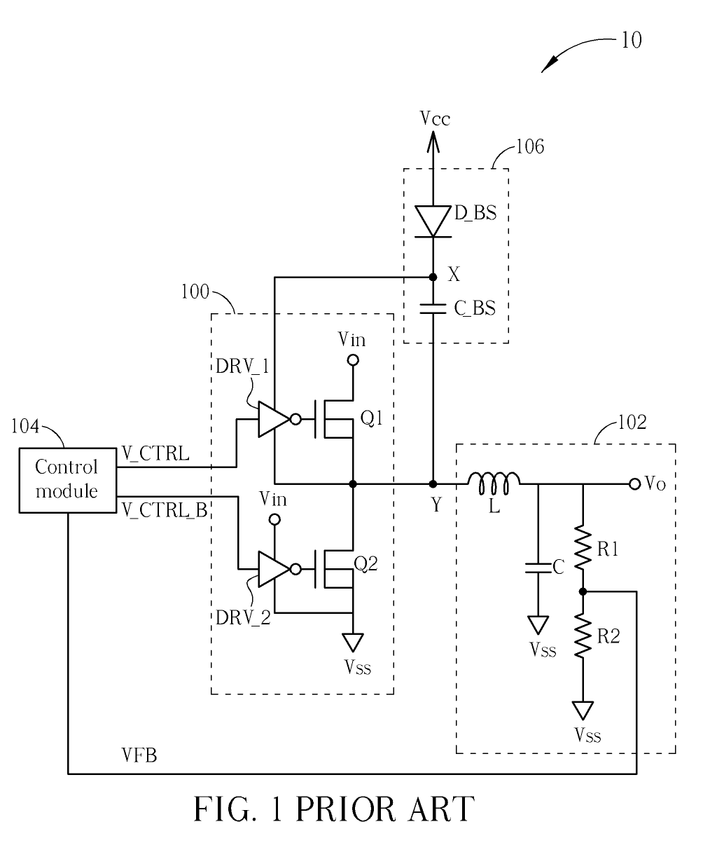

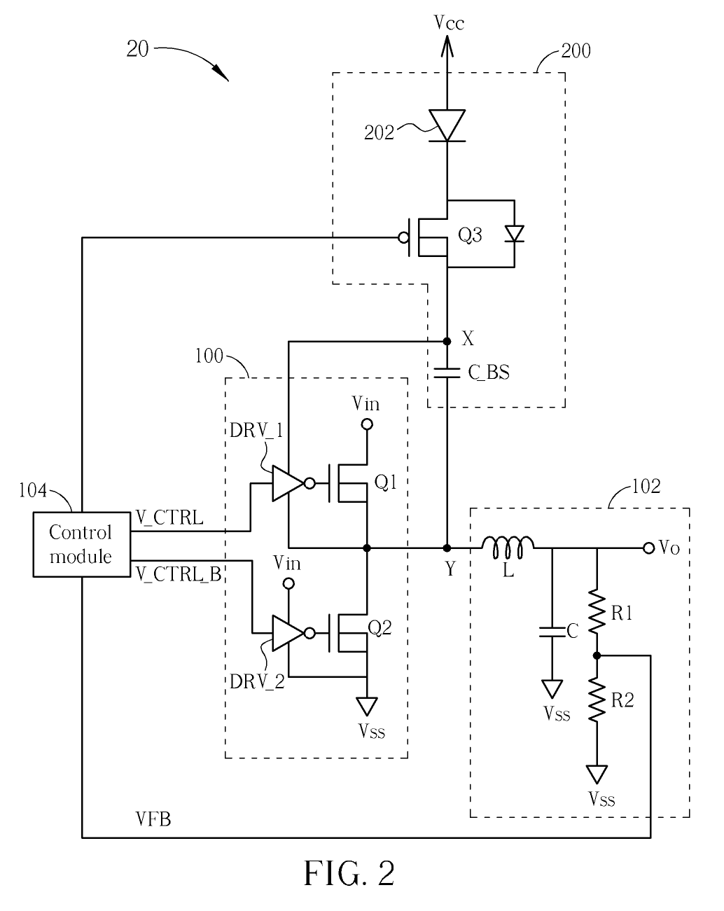

Please refer to FIG. 2, which is a schematic diagram of a direct current converter 20 according to an embodiment of the present invention. The direct current converter 20 is similar to the bootstrap buck converter 10 of FIG. 1 in the structure and operations, and therefore utilizes exactly the same symbols to indicate identical components for the sake of clarity. The direct current converter 20 differs from the bootstrap buck converter 10 in a bootstrap circuit 200 replacing the bootstrap circuit 106 of the bootstrap buck converter 10. In comparison with the bootstrap circuit 106, the bootstrap circuit 200 replaces the diode D_BS by a cascade unit composed of a diode 202 and a transistor Q3. The transistors Q3 is a p-type metal oxide semiconductor field effect transistor (MOSFET), and a drain thereof is coupled to an n-type end of the diode 202. Therefore, by switching the transistor Q3, the direct current converter 20 can have a lower requirement on the voltage bearing ability of the diode 202, such that the diode 202 can be embedded within a chip, to reduce manufacturing process cost and circuit complexity.

With respect to operations of the bootstrap circuit 200, when the power transistor Q1 is disabled and the power transistor Q2 is enabled, the node voltage V_Y approaches the low-potential voltage Vss. Thus, the diode 202 is forward-biased, and the transistor Q3 is enabled, such that the control power terminal (the voltage Vcc) can charge the bootstrap capacitor C_BS. On the contrary, when the power transistor Q1 is enabled and the power transistor Q2 is disabled, the node voltage V_Y approaches the input voltage Vin. Accordingly, the transistor Q3 is disabled, and the node voltage V_X approaches a summation of Vin and Vcc, such that the n-type end of the diode 202 operates in a floating state, and no longer breakdowns.

Therefore, in the bootstrap circuit 200, when the power transistor Q1 is disabled and the power transistor Q2 is enabled, a cross-voltage of the diode 202 is equal to a threshold voltage thereof. When the bootstrap buck converter 20 switches to the mode “Q1: enable; Q2: disable”, since the transistor Q3 would be disabled, the n-type end of the diode 202 operates in a floating state, and no longer burdens with the reverse-biased cross-voltage. That is, the minimum acceptable magnitude of the voltage bearing ability of the diode 200 is the threshold voltage thereof. As a result, the diode 202 is no longer limited by manufacturing process issues, and can be embedded within the chip, so as to reduce manufacturing process cost and circuit complexity.

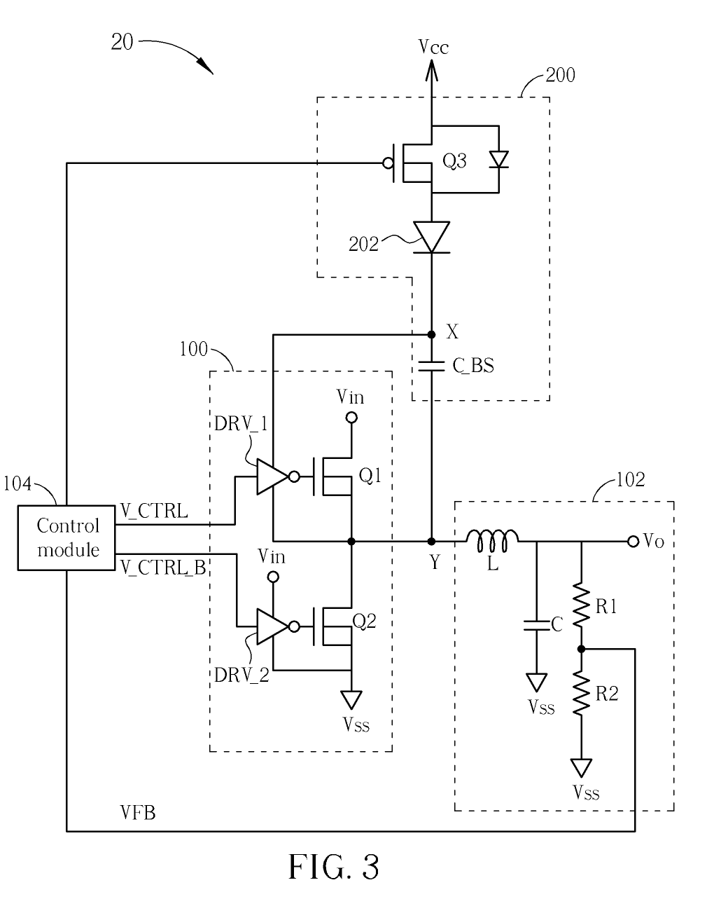

Note that, the direct current converter 20 of FIG. 2 is merely an embodiment of the present invention, and can be accordingly modified and varied by those skilled in the art. For example, positions of the diode 202 and the transistor Q3 can be swapped over, as illustrated in FIG. 3. In such a situation, when the power transistor Q1 is disabled and the power transistor Q2 is enabled, the node voltage V_Y approaches the low-potential voltage Vss. As a result, the transistor Q3 is enabled and the diode 202 is forward-biased, such that the control power terminal (the voltage Vcc) can charge the bootstrap capacitor C_BS. Next, when the power transistor Q1 is enabled and the power transistor Q2 is disabled, the node voltage V_Y approaches the input voltage Vin. Accordingly, the transistor Q3 is disabled, and the voltage of the n-type end of the diode 202 is equal to the summation of Vin and Vcc. Meanwhile, the p-type end of the diode 202 is floating, and the diode 202 is no longer reverse-biased. For the diode 202, no reverse-biased cross-voltage, no problem arising from breakdown issues.

Therefore, no matter the architecture of FIG. 2 or FIG. 3 is applied, the minimum acceptable magnitude of the voltage bearing ability of the diode 202 is the threshold voltage thereof, to prevent limitations from manufacturing processes and thereby embed the diode 202 with in the chip, so as to reduce manufacturing process cost and circuit complexity.

In the prior, the voltage bearing ability of the diode D_BS has to be greater than the control power voltage Vcc. Therefore, due to limitations from manufacturing processes, the diode D_BS must be positioned outside the chip, causing increases in manufacturing cost and circuit complexity. In comparison, by the transistor Q3, the present invention can have a lower requirement of the voltage bearing ability of the diode 202, to prevent limitations from manufacturing processes and thereby embed the diode 202 with in the chip, so as to reduce manufacturing process cost and circuit complexity.

To sum up, the present invention can lower the requirement of the voltage-bearing ability of the diode of the bootstrap circuit, to prevent limitations from manufacturing processes and thereby embed the diode within the chip, so as to reduce manufacturing process cost and circuit complexity.

Those skilled in the art will readily observe that numerous modifications and alterations of the device and method may be made while retaining the teachings of the invention.

What is claimed is:

1. A direct current converter for converting an input voltage to an output voltage comprising:
a first node;
a second node;
an input voltage terminal, for receiving the input voltage;
an output voltage terminal, for outputting the output voltage;
a control power terminal, coupled to a voltage, as a voltage source for a bootstrap circuit;
a low-voltage end, coupled to the lowest voltage;
a control module, for generating a control signal;
a driving-stage circuit, coupled to the input voltage terminal, the first node, the second node, the control module and the low-voltage end, for being driven by a voltage of the first node, the input voltage and the low voltage, to convert the input voltage to the switching signals and output the switching signals to the second node according to the control signal;
an output-stage circuit, coupled to the second node and the output voltage terminal, for converting the switching signals to the output voltage; and
a bootstrap circuit, comprising:
a capacitor, coupled between the first node and the second node; and
a cascade unit, coupled to the control power terminal, the first node and the control module, for controlling a connection between the control power terminal and the first node according to the control signal of the control module.

2. The direct current converter of claim 1, wherein the driving-stage circuit comprises:
a first power transistor, comprising a first end coupled to the input voltage terminal, a second end, and a third end coupled to the second node, for conducting a connection between the first end and the third end according to a signal of the second end;
a second power transistor, comprising a first end coupled to the second node, a second end, and a third end coupled to the low-voltage end, for conducting a connection between the first end and the third end according to a signal of the second end;
a first driving unit, comprising a first end coupled to the first node, a second end coupled to the second node, a third end coupled to the control module, and a fourth end coupled to the second end of the first power transistor, for being driven by the voltage of the first node and a voltage of the second node, to output the control signal to the second end of the first power transistor; and
a second driving unit, comprising a first end coupled to the input voltage terminal, a second end coupled to the low-voltage end, a third end coupled to the control module, and a fourth end coupled to the second end of the second power transistor, for being driven by the input voltage and the low voltage, to output the control signal to the second end of the second power transistor.

3. The direct current converter of claim 2, wherein the first power transistor is an n-type metal oxide semiconductor field effect transistor, the first end is a drain, the second end is a gate, and the third end is a source.

4. The direct current converter of claim 2, wherein the second power transistor is an n-type metal oxide semiconductor field effect transistor, the first end is a drain, the second end is a gate, and the third end is a source.

5. The direct current converter of claim 2, wherein the first driving unit is an inverter, for inverting the control signal and outputting the inverted control signal to the second end to the first power transistor.

6. The direct current converter of claim 2, wherein the second driving unit is an inverter, for inverting the control signal and outputting the inverted control signal to the second end to the second power transistor.

7. The direct current converter of claim 1, wherein the output-stage circuit comprises:
an inductor, coupled between the second node and the output voltage terminal; and
a capacitor, comprising one end coupled between the inductor and the output voltage terminal, and another end coupled to the low-voltage end.

8. The direct current converter of claim 7, wherein the output-stage circuit further comprises:
a first resistor, coupled between the output voltage terminal and the control module; and
a second resistor, coupled between the control module and the low-voltage end.

9. The direct current converter of claim 7, wherein the control module is further utilized for adjusting the control signal according to a dividing voltage generated by the first resistor and the second resistor.

10. The direct current converter of claim 1, wherein the cascade unit comprises:
a diode, comprising a p-type end coupled to the control power terminal, and a n-type end; and
a transistor, comprising a first end coupled to the n-type end of the diode, a second end coupled to the control module, and a third coupled to the first node, for controlling a connection between the first end and the third end according to the control signal received by the second end.

11. The direct current converter of claim 10, wherein the transistor is a p-type metal oxide semiconductor field effect transistor, the first end is a drain, the second end is a gate, and the third end is a source.

12. The direct current converter of claim 1, wherein the cascade unit comprises:
a transistor, comprising a first end coupled to the control power terminal, a second end coupled to the control module, and a third end, for controlling a connection between the first end and the third end according to the control signal received by the second end; and
a diode, comprising a p-type end coupled to the third end of the transistor, and a n-type end coupled to the first node.

13. The direct current converter of claim 12, wherein the transistor is a p-type metal oxide semiconductor field effect transistor, the first end is a drain, the second end is a gate, and the third end is a source.
